(19) United States
(12) Patent Application Publication
(10) Pub. No.: US 2021/0007551 A1
(43) Pub. Date: Jan. 14, 2021

(54) Collapsable Bar-B-Que Grill

(71) Applicant: Gregory Allen Claybon, Dallas, TX (US)

(72) Inventor: Vaughn Wayne Claybon, SR., Dallas, TX (US)

(21) Appl. No.: 16/501,966

(22) Filed: Jul. 12, 2019

(51) Int. Cl. A47J 37/07

(52) U.S. Cl. CPC A47J 37/0763; A47J 37/0704

(57) ABSTRACT

To begin, you must first assemble the unit. Unlock the latches that locks down the lid (or top). Remove the lid (or top) from the base pan. All of the parts to the grill is stored inside the base pan.

Take the front panel out first and place it in its place on the front of the base pan. Then take out the next panel which is the rear panel and place it on the base pan in its place at the back. Next you remove the right side panel and then the left side panel, place these on either side of the base pan in their positions. Then place the grilling plate on the shelves located on either side of the front and rear panels. Then insert the two hinges located at rear of the lid (or top) into the slots located at the rear of the base pan, now the grill is completely assembled and ready to use.

To disassemble the grill do everything in reverse order.

There are a set of legs underneath the base pan that can collapse for transporting and storing. By collapsing the legs makes it easier to carry, transport and store away in a closet with ease.

### DETAILED DESCRIPTION OF THE INVENTION

It is a unique and only one of its kind. It can be used to cook meat and veggies over hot coals. It has four sides that can be removed. It has a removable lid (or top) that can be removed and replaced before and after using. All of its parts can be stored inside the base pan. All of its parts are made of metal. When assembled it can be used as an ordinary Bar-B-Q grill. When disassembled it can be easily carried around from place to place like a suit case which makes it easier to store because it does not need much space.

It's compacted enough for storage in small spaces and you do not need to leave it out in the rain and sun to rust away.

It has collapsible legs to stand on or to sit down on even when using it.

### BACKGROUND OF THE INVENTION

Our Bar-B-Q charcoal burning grill is like no other Bar-B-Q grill. Like all other Bar-B-Q grills it is used to cook meat and other foods.

Our Bar-B-Q grill has to be assembled before using and disassembled after using to make it easier for transporting and storage.

Our Bar-B-Q grill falls under the utility patent classification because of how it must be assembled before using.

Unlike other Bar-B-Q grills that once they are assembled they must stay assembled before during and after using.

I, Vaughn Wayne Claybon and Gregory Allen Claybon, has invented a new design for a new collapsible Bar-B-Q charcoal burning grill as set forth in the following specifications. The claimed collapsible charcoal burning Bar-B-Q grill is used for cooking outside. Where in the improvement comprises of seven different and separate parts to make up one cooking grill. All of its parts are stored inside the base pan for keeping until use. The claimed collapsible Bar-B-Q grill can be carried from one place to another, easily transported or stored in a closet space.

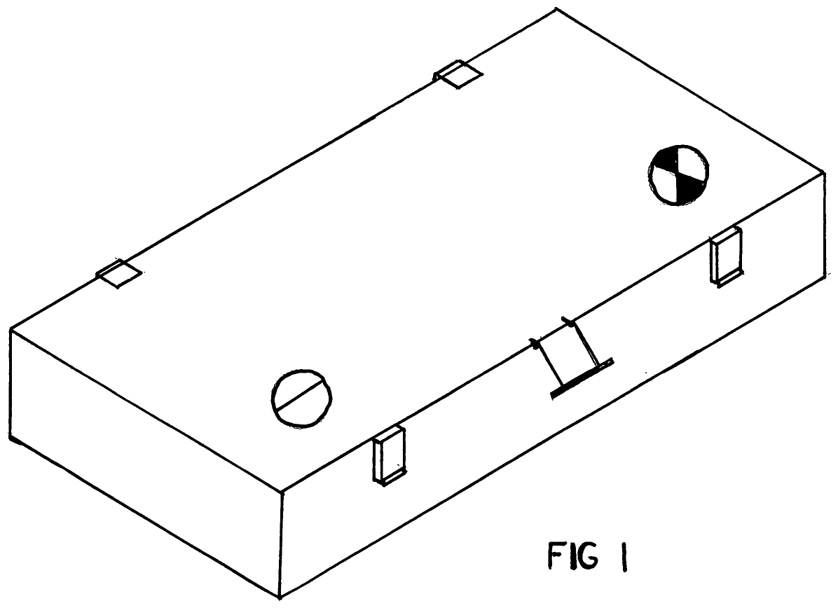

FIG. 1: Is a perspective view of our collapsible Bar-B-Q grill in its closed and dissembled state with its collapsible legs folded under for easy transport, carrying or storing.

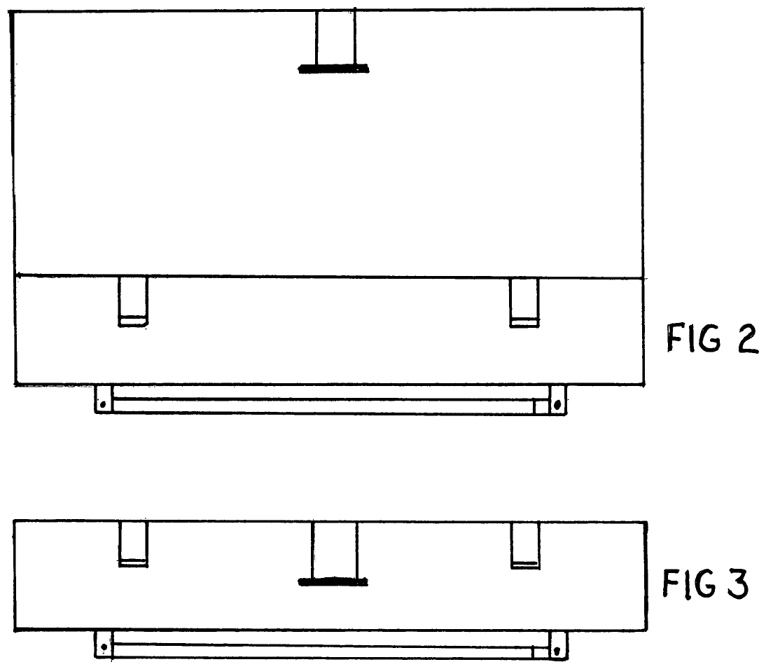

FIG. 2: Is a frontal elevated view of our collapsible Bar-B-Q grill. This view shows the grill in its fully assembled state and ready to be used.

FIG. 3: Is also a frontal elevated view of our new collapsible Bar-B-Q grill in its disassembled state and ready for carrying, transporting and storing.

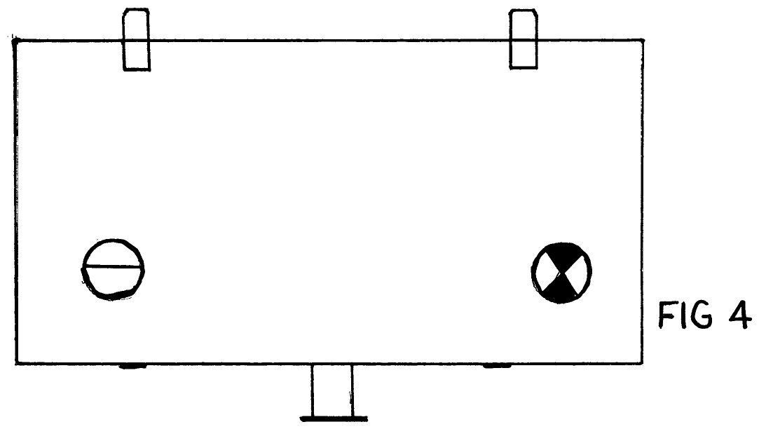

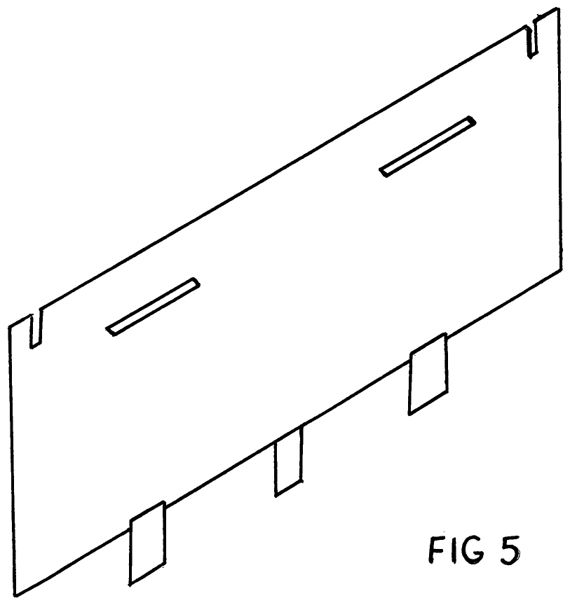

FIG. 4: Is a top plan view of the lid (or top) of the collapsible Bar-B-Q grill. The lid (or top) has two hinges in the rear of the lid with a handle in the middle front.

FIG. 5: Is a perspective view of the front side panel of the collapsible Bar-B-Q grill thereof.

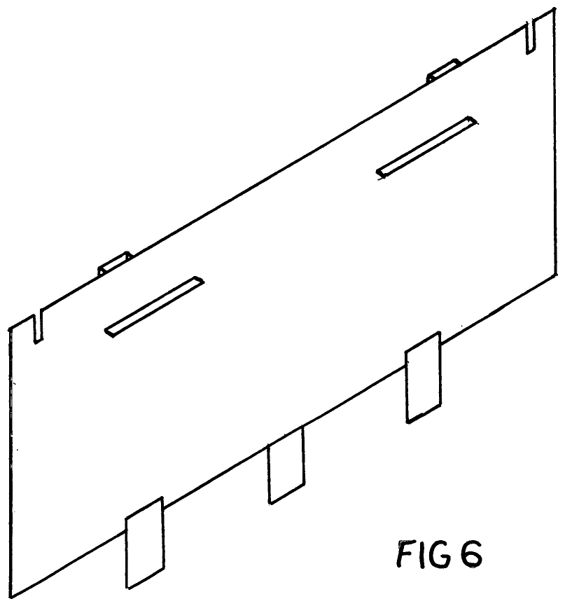

FIG. 6: Is a perspective view of the rear side panel of the collapsible Bar-B-Q grill thereof.

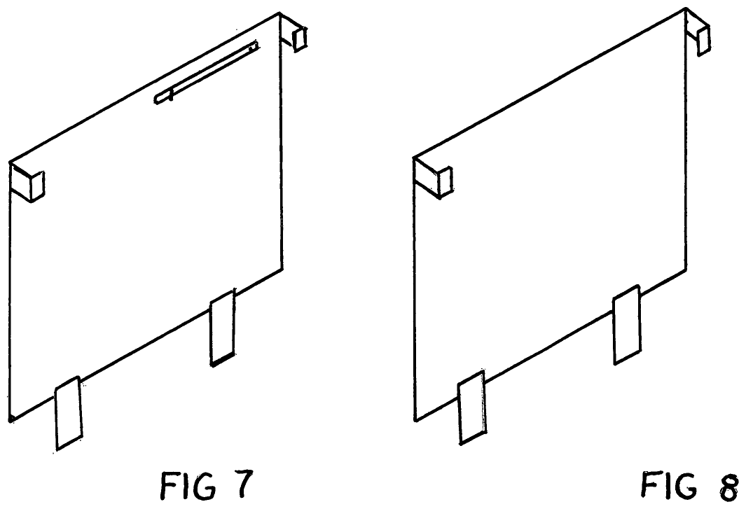

FIG. 7: Is a perspective view of the left side panel of the collapsible Bar-B-Q grill thereof.

FIG. 8: Is a perspective view of the right side panel of the collapsible Bar-B-Q grill thereof.

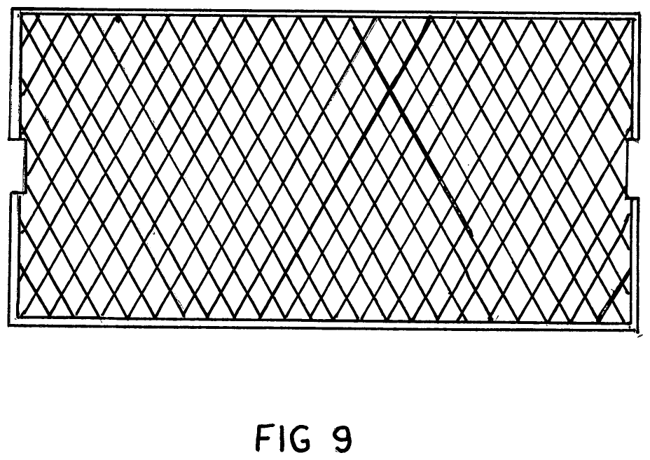

FIG. 9: Is a top plan view of the grilling section for the new collapsible Bar-B-Q grill thereof.

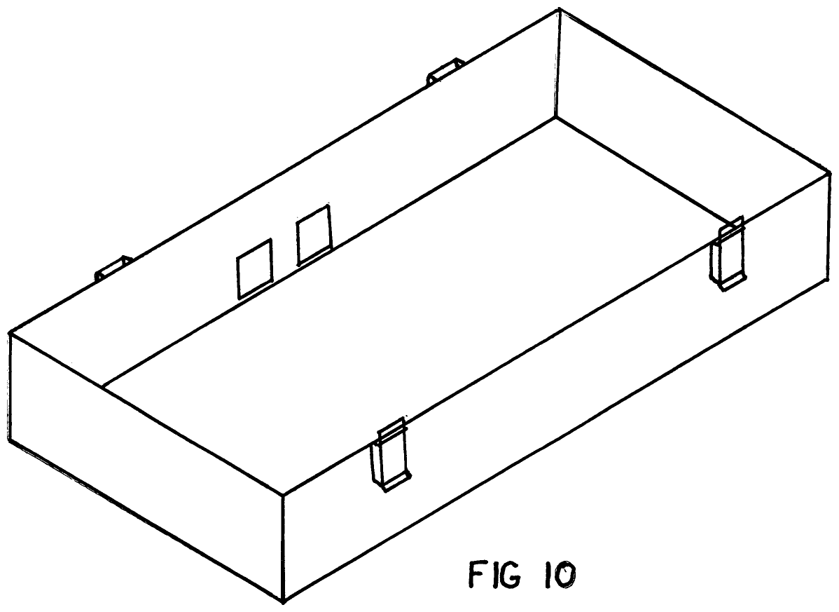

FIG. 10: Is a perspective view of the base pan area of our collapsible Bar-B-Q grill thereof.

We claim:

1. The ornamental and utility for a new collapsible Bar-B-Q charcoal burning grill as shown and described above.
